(19) United States
(12) Patent Application Publication
(10) Pub. No.: US 2002/0120569 A1
(43) Pub. Date: Aug. 29, 2002

(54) System and method for communication between remote locations

(76) Inventor: Mark E. Day, Nashville, TN (US)

Correspondence Address: Paul A. Taufer, Schnader Harrison Segal & Lewis LLP, Suite 3600, 1600 Market Street, Philadelphia, PA, 19103, US

(21) Appl. No.: 10/016,882

(22) Filed: Dec. 14, 2001

Related U.S. Application Data
(63) Continuation-in-part of application No. 09/844,969, filed on Apr. 26, 2001.
Application No. 09/844,969 is a continuation of application No. 09/616,449, filed on Jul. 14, 2000, now abandoned.
Application No. 09/616,449 is a continuation-in-part of application No. 09/303,173, filed on Apr. 30, 1999, now Pat. No. 6,239,722.
Application No. 09/303,173 is a continuation of application No. 08/949,440, filed on Oct. 16, 1997, now Pat. No. 5,986,574.
(60) Provisional application No. 60/256,390, filed on Dec. 15, 2000.

(51) Int. Cl. G06F 17/60

(52) U.S. Cl. 705/40

(57) ABSTRACT

A communication system regulates communication between a utility and a customer. The communication system can be adapted as a payment metering system by incorporating a utility host, a meter, and customer interface. A payment medium can be used for transferring payment onto the system. Meter read information can be uploaded onto the payment medium where desired. A control can also be included in the system and located remote from the meter to accommodate monitoring of the meter where desired and any additional communication.

### CROSS-REFERENCE TO RELATED APPLICATIONS

This application claims the benefit of U.S. provisional patent application Serial No. 60/256,390 filed Dec. 15, 2000 and is a continuation-in-part of U.S. patent application Ser. No. 09/844,969, filed Apr. 26, 2001 which is a continuation of U.S. patent application Ser. No. 09/616,449 filed Jul. 14, 2000, now abandoned, which is continuation-in-part of U.S. patent application Ser. No. 09/303,173 filed Apr. 30, 1999, now U.S. Pat. No. 6,239,722 B1 which is a continuation of U.S. patent application Ser. No. 08/949,440 filed Oct. 16, 1997, now U.S. Pat. No. 5,986,574.

### BACKGROUND OF THE INVENTION

1. Field of the Invention

The present invention relates generally to utility monitoring systems and more particularly to systems for communicating between remote locations.

2. Description of the Prior Art

Metering devices have for years been used in the monitoring of utility consumption, such as water, electricity, gas, to name a few. Utility providers have typically utilized metering devices at the various locations of its customers, i.e., residences or businesses, in order to monitor the consumption of a given utility. The utility provider would monitor the utility consumption by reading the various metering devices at each of the customer locations. In recent years, it has been recognized that the costs incurred by the utility provider have significantly increased in view of the numerous employees required to manually read each of the metering devices at the customer locations; especially in view of the higher number of customers of many current day utility providers.

In view of the foregoing, there is seen a need to provide a system for monitoring of metering devices from remote locations in order to reduce both the time and costs associated with manual reading of metering devices.

### SUMMARY OF THE INVENTION

One aspect of the present invention discloses a system and method for a utility provider to monitor a plurality of metering devices from a remote location. For this purpose, the present invention discloses a meter for measuring a local parameter, such as a given utility, a user interface in communication with the meter and a control that receives data corresponding to the measurement by the meter.

In another aspect of the present invention, data received by the control corresponding to a meter measurement can be transmitted as defined signals from the meter to the control, such as over any wired or wireless medium or any combination of the two. Alternatively, the meter data may be transferred from the meter to another device, for example, uploaded onto any storage medium, such as onto an integrated circuit or “smart” card.

In yet another aspect of the present invention, the data acquisition system of the present invention may be used to allow payment and pre-payment for utility services and for the provision of information to and from the customer. This may include, for example, data acquisition, automatic disconnect/reconnect (auto-interruption), better management of high transient housing, real time utility usage information, usage history, flexible billing/payment methods, automatic debt management, purchase/payment history, and messaging.

These and other aspects of the present invention will become more readily apparent when taken into consideration with the following description and the attached drawings.

### BRIEF DESCRIPTION OF THE DRAWINGS

FIG. 1 is a partly schematic and partly block diagram of an embodiment of a communication system in accordance with the present invention.

FIG. 2 is a partly schematic and partly block diagram of an embodiment of a concentrator of FIG. 1.

FIG. 3 is a block diagram illustrating protocol layering associated with a Consumer Electronics Bus Standard.

FIG. 4 is a partly schematic and partly block diagram of an embodiment of a prepayment system in accordance with the present invention.

FIG. 5 is a flow chart illustrating a payment cycle in accordance with the preferred embodiment of the present invention.

FIG. 6 is a flow chart illustrating a prepayment cycle in accordance with the preferred embodiment of the present invention.

### DETAILED DESCRIPTION OF THE PREFERRED EMBODIMENT

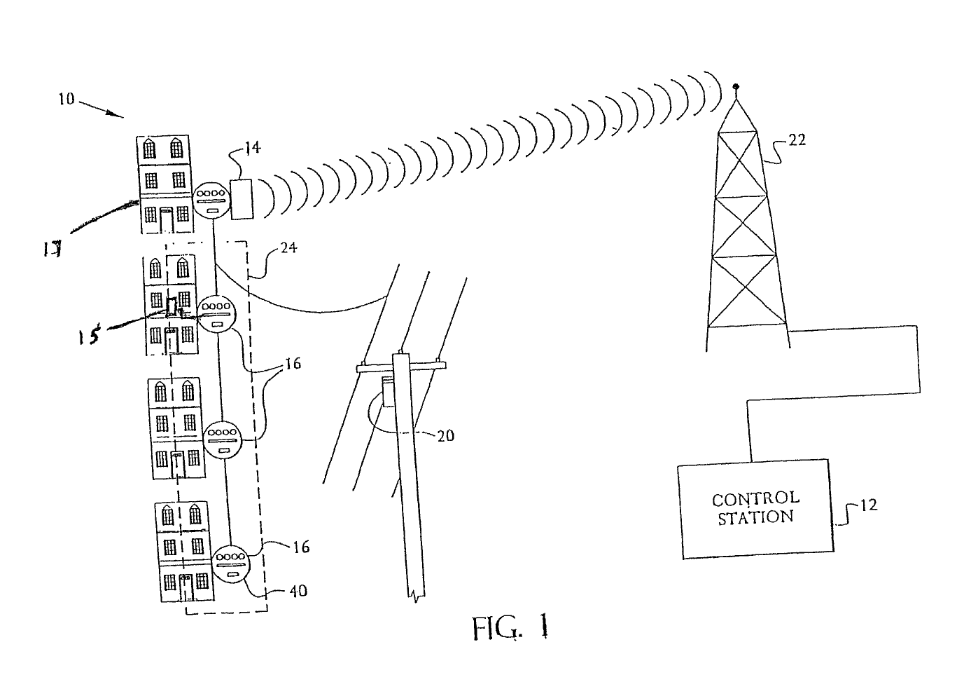

Referring now to the drawings in detail, wherein like reference numerals indicate the like elements throughout the several views, there is shown in FIG. 1 a partly schematic and partly block diagram of a communication system in accordance with an embodiment of the present invention. The communication system 10 as is shown in FIG. 1 comprises, as portions thereof, control means 12, a defined number of relay means 14 in communication with the control means 12 and at least one and preferably a plurality of servicing means 16 in communication with the relay means 14, the details of which will be more fully set forth hereinafter.

In accordance with the present embodiment, the communication system 10 is adapted for use by a utility provider for customer communication. As should be understood, however, the communication system 10 in accordance with the present invention has broader application and can be used for any desired application. The control means or station 12 preferably is located at a desired location and is capable for transmitting and receiving data in the form of signals, for example, a computer, microprocessor or similar device, i.e., a Pentium® based PC can be employed. In the present embodiment, the control means 12 is located at the site of the utility provider, although any other desired location can also be utilized for this purpose. Although not shown, the control means 12 can be provided in communication with other devices as well, such as one or more personal computers or computer terminals, for example, for display, for data input or processing or other desired functions. In accordance with the present invention, the data signals transmitted over the communication system 10 between the control means 12, relay means 14 and servicing means 16 can be carried by any desired medium, such as either by any wireless medium, such as radio frequency (RF) or infrared (IR) signals, or can be carried over any wire medium, such as 110 volt AC power line (PLC), twisted pair (TP) cable, fiber optic cable and coax cable. In the present embodiment, the data signals transmitted between the control means 12 and the relay means 14 preferably are carried over both wire and wireless mediums, which is described in more detail below.

As illustrated in FIG. 1, the control means 12 is in communication by a wire medium with switching means comprising at least one radio tower 22, which in turn is in communication with the relay means 14 via a suitable wireless medium. In a preferred embodiment, the control means 12 and relay means 14 are in communication with the radio tower 22 via a publicly available Wide Area Network (WAN), for example, such as Sprint PCS, AT&T Wireless, and Verizon Wireless. In this manner, the signals received by the WAN provider over wire signals from the control means 12 are transmitted as suitable wireless signals, preferably RF signals, from the radio tower 22 to the relay means 14. Similarly, in the presently preferred embodiment, the wireless signals received by the WAN provider from the relay means 14 are transmitted over wire to the control means 12.

The relay means 14 in the present embodiment shown in FIG. 1 is preferably in communication over a suitable wire medium with the servicing means 16, although as should be understood a suitable wireless medium can also be used. In accordance with the present invention, there are a defined number of relay means 14, with each relay means 14 being in communication with a selected number of servicing means 16 comprising a servicing group 24. As illustrated in FIG. 1, in the present embodiment, there is shown the servicing group 24 comprising three servicing means 16 in communication with the one relay means 14. In a presently preferred embodiment, the servicing group 24 is in communication with the relay means 14 via a Local Area Network (LAN). More preferably, communication between the servicing group 24 and the relay means 14 is accomplished using a Consumer Electronics Bus (CEBus) standard, which is described in more detail below, although as should be understood, other suitable protocols and standards can also be used for this purpose, such as LonWorks or Bluetooth. Also, preferably communication between the relay means 14 and the control means 12 is accomplished using a suitable WAN protocol.

The CEBus standard is a home automation standard developed by the Electronics Industry Association and the Consumer Electronics Manufacturers Association to provide economical LAN communications among consumer products within the home. The CEBus standard is explained in greater detail in Electronics Industries Association/IS-60, “Home Automation Standard” (CEBus) December 1989, which is incorporated herein by reference. The CEBus protocol was designed to cover communications between various types of products over any of a number of accepted media that support CEBus, which includes PLC, TP cable, coaxial cable, IR, RF and fiber optic cable.

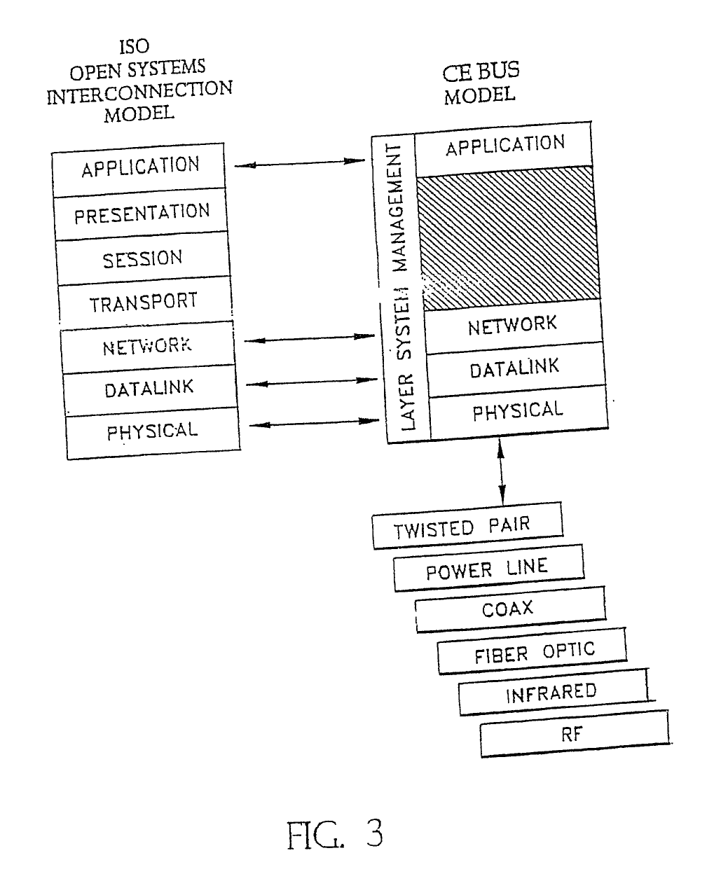

As illustrated in FIG. 3, the CEBus standard is a four layer model based on the International Standards Organization's (ISO) Open Systems Interconnection seven layer model for communication. The four layers utilized in the CEBus protocol include application, network, data link and physical layers, which are defined in the following paragraph.

The physical layer is the form of signal and provides the characteristics to activate, maintain and deactivate the physical links passing the stream of communication symbols. The physical layer exchanges symbols with the data link layer, encoding and decoding the symbols to and from the medium states. The states required to represent the symbols are modulated and demodulated with the medium carrier by the physical layer. The data link layer provides the means for establishing and maintaining individual data links, provides for the transfer of information over the physical link with the required synchronization, error control and flow control functions, provides for the encapsulation and de-encapsulation of the messages exchanged between itself and the network layer, and exchanges symbols and medium status between itself and the physical layer. The network layer sets basic standards for formatting of information once the link is established and provides the switching and routing functions needed to establish, maintain and terminate connections and data transfer. The application layer specifies how service is received or experienced and is responsible for managing the communication access.

In accordance with the present invention, preferably each of the servicing means 16 comprises means for transmitting and receiving data for communication with the control means 12 via the relay means 14; for example, conventional transmitter and receiver units can be utilized for this purpose. In a presently preferred embodiment illustrated in FIG. 1, each of the servicing means 16 comprises a metering device and located at the site of the customer of the utility provider, i.e., residencies or businesses. For example, each of the metering devices 16 can comprise a typical rotary, electromechanical or electronic type utility meter, although other suitable types of metering devices would also be applicable. In addition, each metering device 16 preferably includes means for measuring an amount of usage of a utility, such as electricity, gas or water, as examples, for the specific location to which the metering device 16 is connected. In the regard, the metering devices 16 preferably are of the incremental type similar to typical metering devices. In addition, the metering devices 16 also preferably include means for processing and storing of the data associated with the measured amount of utility usage, for example, a microprocessor with suitable storage means, such as random access memory (RAM) and read only memory (ROM). This data might then include accumulated usage in kWh since beginning of current billing cycle, accumulated usage in dollars since beginning of current billing cycle, etc. As should be understood, in other embodiments where the servicing means 16 are not in the form of metering devices, the foregoing features associated with monitoring of a given utility would not be required.

In accordance with the present embodiment, the metering devices 16 are each connected via power lines to the relay means 14, either by a direct connection between each metering device 16 to the relay means 14 or, as shown in FIG. 1, with each of the metering devices 16 being connected via power lines in a series and one of the metering devices 16 then being connected to the relay means 14. In other embodiments, the metering devices 16 can be connected by other wire mediums and/or wireless mediums to the relay means 14 as well, for example, a wireless medium may be suited where the metering devices are used for measuring gas, in view of typical gas metering devices which do not require connection to a power source, whereas a wire medium may be more suited for embodiments in which the metering devices are for measuring electricity, as most typical metering devices used for measuring electricity usage are connected to a 240 volt power outlet, thus easily adapted for power line communication. As should be understood, the foregoing examples are for illustration purposes only and are not intended to limit the scope of the present invention. In the present embodiment, preferably the communication system 10 also includes at least one and typically a plurality of distribution transformers 20, positioned between one or more metering devices 16 and the relay means 14, for scaling downward to 220 volts the typically higher voltages generated over the power lines. In this manner, a LAN is established between each of the metering devices 16 and the relay means 14.

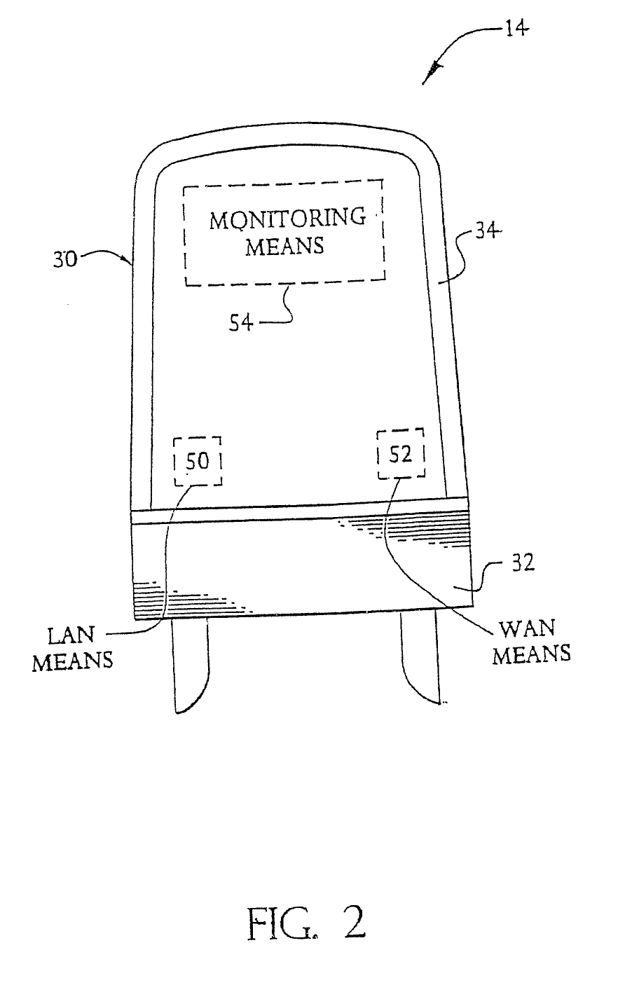

In accordance with the present invention, the relay means 14 can be positioned at any desired location within the communication system 10; for example, the relay means 14 can be located on a distribution pole or other location. In the present embodiment, preferably the relay means 14 comprises a concentrator in the form of a meter and positioned at the location of a customer. The concentrator meter 14 in accordance with an embodiment of the present invention is illustrated in detail in the block diagram of FIG. 2. The concentrator meter 14 preferably includes LAN means 50 for receiving and transmitting data over the local area network, such as a conventional transmitter and receiver. In addition, in the present embodiment, the concentrator meter 14 also preferably includes WAN means 52 for communicating (receiving and transmitting) data over the wide area network with the control means 12 via the switching means 22, such as a conventional WAN radio; for example, the Code Division Multiple Access type, commercially available from Qualcomm, the Time Division Multiple Access type, commercially available from Ericsson, and the Cellular Digital Packet Data type, commercially available from Sierra Wireless and Novatel. In addition, similar to the metering devices 16, preferably the concentrator meter 14 includes monitoring means 54 for measuring an amount of usage of a utility at a given location, similar to conventional incremental type metering devices including those of the rotary, electro- mechanical and electronic types. The concentrator meter 14 in the present embodiment also preferably includes means for processing and storing data associated with both the amount of utility usage measured by the concentrator meter 16 as well as received from the metering devices 16, for example, a conventional microprocessor and storage means, such as suitable amounts of RAM and ROM.

In the present embodiment, the concentrator meter 14 further preferably includes means for exchanging between two media, for example between radio frequency signals and signals transmitted over the power lines in the present embodiment, such as a conventional router device. The concentrator meter 14 can also include a battery for providing a backup power source. In the present preferred embodiment, the concentrator meter 14 preferably also includes a housing into which each of the foregoing elements are disposed and retained as a unit. For example, as shown in FIG. 3, the housing 30 is generally elongated and substantially cylindrical in cross section having an inner cavity into which the components of the concentrator meter 14 are mounted, such as the LAN means 50, WAN means 52 and monitoring means 54 as illustrated. In the present embodiment, the housing 30 comprises a base 32 to which the elements of the concentrator meter are attached and a cover 34, preferably clear, such as of glass or plastic, and having a cavity receiving the elements of the concentrator meter 14 and attached to the base 32, although as should be understood, the housing 30 can be of other configurations as well. Similar to the servicing means 16 described above, the relay means 14 in other embodiments may be utilized for communication between the control means 12 and servicing means 16 without also providing the function of a meter, and accordingly the foregoing elements directed to providing the function of the meter can be eliminated where desired.

The operation of the communication system 10 in accordance with the present embodiment will now be described. As described earlier, one advantage of the communication system 10 in accordance with the present embodiment is that the utility provider can monitor the utility usage of a customer from a remote location. For this purpose, a command can be generated automatically from the control means 12, such as by a software program, or manually from a technician or other personnel to instruct a given metering device at a particular customer location to transmit the measured amount of utility usage. Alternately, the metering devices 16 can be preprogrammed to automatically transmit the utility usage data to the control means 12 at specified intervals.

For purposes of this illustration, a signal is initially generated by the control means 12 to a particular metering device 16. In accordance with the CEBus protocol, the signal generated from the control means 12 is preferably generated in packets of data in digital form and incorporates within the packet an identifier, such as a number, associated with the particular metering device or devices which monitoring is desired. The data signal is transmitted from the control means 12 over the wire medium, such as telephone lines, which are received by the WAN provider for re-transmission to the concentrator meter 14. The WAN provider exchanges the data from the wire to wireless medium, such as by a router, and then transmits the data as radio frequency signals to the concentrator meter 14. The concentrator meter 14, in turn, exchanges the data received over the wide area network for transmission via power line communication over the local area network to the metering devices 16.

In the present embodiment, the concentrator meter 14 can be pre-programmed so as to transmit a data signal only to a particular metering device or devices 16 depending on the particular meter identified in the packet of data. Alternatively, the concentrator meter 14 can be programmed to transmit the data signals to each of the metering devices 16, with the metering devices 16 in turn programmed to respond only when its particular meter identifier is detected. For purposes of this illustration, it will be assumed that the concentrator meter 14 is constructed so as to transmit data to each of the metering devices 16, with the data generated from the control means 12 including an identifier for a particular metering device 16 designated as number “1” to monitor utility usage. Further, preferably the control means 12 correlates the metering device 16 designated as number “1” with the appropriate concentrator meter 14. In this example, the meter device 16 designated as number “1” is illustrated in FIG. 1 by the metering device 40. The metering device 40 receives the data signal from the concentrator meter 14 and in response transmits data in signal form incorporating a reading of the amount of utility usage measured at the particular customer location. In a similar manner to that described above, the signal from the metering device 40 is passed through the concentrator meter 14 and is received via the WAN provider by the control means 12. In this manner, a read of the metering devices 16 at each of the customer locations can be obtained by the utility provider.

This usage information can be communicated in real time through the use of a series of displays, which give the customer selective indications as to the current situation of their utility usage status. These indications are designed to allow better management of electric service.

Depending on the payment mode of the individual customer, this display may show a monetary value indicating the current status of the customer bill. In the prepayment mode this value indicates the amount remaining. In the postpayment mode the value indicates the current usage amount, inclusive of taxes, base charges, and accumulated kWh usage. Not included in this amount shall be other charges such as water heater or other adjustments.

The system may also provide a display showing the rate of usage per hour in money. This display has been shown through customer surveys of existing systems to be one of the most useful displays. The current rate being charged may be shown, preferably in terms of money per kWh. The rate shown at a specific time will normally be in relation to the accumulated kWh consumption as per utility business practices or instructions. The may also provide displays indicating recent history usage, such as money used today”, money used yesterday, and money used this month.

Another advantage of the present invention is its application for transmission of data between a plurality of locations. For example, in the communication system 10 described above, communication is established between the utility provider, via the control means 12, and the customers of the utility provider, via the servicing means 16 which are in the form of metering devices, for monitoring the amount of usage of a given utility. As should be understood, the communication system of the present invention is not limited to use by a utility provider to monitor utility usage of its customers, rather the communication system of the present invention is applicable for any communication between two locations.

For example, in connection with use by a utility provider, the control system 10 described above can also be adapted so that the utility provider can communicate with one or more customers, via the metering devices 16, to perform, in addition to automatic meter reads on any desired basis, other functions as well, such as outage/restoral monitoring, customer consumption readings on request, Time-Of-Use (TOU) reporting to customers, billing capability, tamper detections/deterrence and deferment of peak use through TOU rate information. In addition, through in-home user-interfaces illustrated at 15 in FIG. 1, such as in-home terminals, smart phones, smart thermostats, etc., a utility provider in addition to reading of meters, or other entities that do not incorporate the feature of meter reading within the servicing means 16, can communicate with customers for Real Time Pricing (RTP), remote service connect/disconnect, messaging services, such as headline/local news, financial quotes, energy information, etc., and home monitoring/control, such as break-in and personal security, appliances, etc.

The system allows for the downloading of custom (short form) and pre-defined messages to particular customer accounts. While these messages are typically intended to be used as reminders for payment operations, they may be used for other purposes. The field equipment is also preferably capable of supporting the storage of up to 5 full screens of messaging (240 characters).

Messages preferably have a start date and an end date associated with them. They may also have a priority associated with them, such as low, medium, and high. Priorities of messages may be reflected by flashing the LED on the display terminal. The color of the LED may be used to reflect the priority of the message; e.g., low-green, medium-yellow, and high-red.

Upon reading of a message the flashing LED may be discontinued. High priority messages are preferably confirmed as read back to the host. High priority messages also preferably invoke PIN code protection to the message group.

Downloading a message to field equipment that already has five full messages preferably results in the overwriting of the oldest message present unless that message is a high priority message. In that case, the oldest message of lower priority should be overwritten. If a message is to replace a specific existing message in the system, the host system preferably first downloads the old message followed by the new message.

The present invention is also capable of printing the long form message that corresponds to the short form message (downloaded to field equipment). The system administrator preferably decides if the printed long form message will be mailed to the customer. This may occur automatically or based on review of the administrator.

The present invention is also capable of reporting billing failures due to lack of communications with the field equipment. The start date of messages associated with billing is preferably X days after the date at which the display has billed the customer. The number of days “X” is programmable. The end date is associated to the customer rating.

Still another advantage of the present invention is provided by the relay means 14 for communication between the control means 12 and servicing means 16, which provides for efficient operation in that only one relay means 14 is required for a plurality of servicing means 16. In addition, the relay means 14 when in the form of the concentrator meter 14 provides for even greater efficiency since the features of a meter and relay means between the metering devices 16 and control means 12 are combined into a single unit and which can be provided directly at a customer location.

Another advantage of the present invention is that various systems are disclosed that are very flexible and can be structured in a number of different configurations based on the desired operational characteristics of the system.

As an example, one aspect of the present invention discloses a system and method for a utility provider to monitor a plurality of metering devices from a remote location. For this purpose, the present invention discloses various configurations of metering devices, such as one or more metering devices 16 and/or one or more concentrator meters 14, each being used for measuring a local parameter, such as a given utility.

The system thereby provides a means by which customer movements may be easily handled. In order to support the incorporation of new customers to the system, for example, new customer information must be manually entered. The customer data may be provided by the utility. Upon entering a new customer and location into the system, a field hardware installation date must be specified.

The host need not be responsible for actual scheduling of installation and training operations for the system. It should however be able to generate, based on a specified date range, a list of accounts to be installed. An actual report from the hardware in the field and subsequent downloading of configuration data is preferably used in the activation of the account. The customer may schedule a move out date by simply calling the appropriate utility support line. The customer must supply a move-out date. Additionally, if power is to be disconnected from the residence due to vacancy, the customer may actually specify a move out time. At that date and time, the readings of the system are frozen and reported to the host. This information is then reported to the utility mainframe for closing of the account. The account on the host shall be made inactive but not closed until instructed to be closed by the administrator. This command may be accomplished either automatically or manually depending on the extent of the commands supported via the file transfer methods outlined elsewhere in this document.

Should the resident specify a move out date which is already passed, the host operator may, at his discretion, select usage closest to the date specified from the customer history to generate a final bill via the utility mainframe or inform the customer that the earliest that the account can be closed is during the next regularly scheduled communications period of the FPS field hardware. If the telephone service is already disconnected from the customer premises, the utility would normally be required to send someone to the residence to take a manual meter reading in order to close the account. During that visit the service person may either manually disconnect the system or remove the system.

In the case where a customer is moving out and the new resident is known before the customer moves out, the move out and move in may be scheduled to occur simultaneously. By specifying a date and time, the system shall upload all pertinent usage information to the host to process the account and all new customer information shall be downloaded to the system. Usage history for the residence should remain the same for both customers. Payment history of the old customer shall be removed and replaced with the new customer payment history if available.

Should there be a lapse in phone service between the old and new resident, the FPS field hardware may hold the previous information until communications to the host can be established, since the new resident was known prior to the move out date of the old resident. The new customer will have billing information available immediately. However the new customer may not be able to make payments until phone service is established. Likewise the final report of usage from the old customer will not be available to the FPS host until phone service is re-established.

While there can be many variations to the situations described above, the basic operations to be performed shall remain the same. Upon receiving a valid move out command associated with a date and time, the system may freeze the usage information based on the date and time and eliminate availability of any old customer specific information via the display. New customer information will become available at the display when it is known. It can actually be downloaded to the field equipment prior to, or after the actual move out date of the old customer. (If the data is downloaded prior to the move out date of the customer, it will not be accessible by the old customer.)

Further, a defined number of user interfaces can also be provided in communication with any arrangement of metering devices 16/concentrator meters 14. For purpose of this illustration, as shown in FIG. 1, the system includes either a metering device 16 or a concentrator meter 14 located at a designated remote location, such as located at the exterior of residence 17, and at least one user interface 15 is also provided, such as located in the interior of residence 17 and in communication with the respective metering device 16 or concentrator meter 14. In this embodiment, the user interface 15 is preferably in power line communication with the respective metering device 16 or concentrator meter 14; for example, the user interface can be plugged into any standard 110 Volt power outlet as described above. As should be understood, the user interface 15 can be in communication with the respective meters 14 and/or 16 by any other suitable means as well where desired, such as by any desired type of wired or wireless communication. In other embodiments where desired, the concentrator meter 14 can be incorporated into the user interface 15, or where the meter function is not required, the relay 14 discussed above without any metering operation can be incorporated into the user interface 15. In a similar manner, the meter 16 can also be incorporated into the user device 15. The user interface 15 can be provided in a number of different configurations and include a number of different features as indicated above. In this embodiment, each user interface 15 can communicate for a variety of desired purposes with the respective meter 16/concentrator meter 14 and/or the control 12 depending on the operational characteristics of the system.

In addition, in accordance with the present invention, billing and payment features can also be provided as a part of the overall system. The billing and payment features can be incorporated either into the various embodiments constructed as a utility service/monitoring system or other monitoring system as well as into any other type of system that does not incorporate any metering or other monitoring function, such as into any of the various embodiments of communication systems. Examples of billing and payment systems for dispensing utility service are illustrated in U.S. Pat. No. 5,146,067; 4,795,892 and 4,731,575, each assigned to CIC Systems, Inc., a wholly owned subsidiary of the assignee of this application, CIC Global, LLC, the entire disclosures of these patents are incorporated by reference herein.

As understood to those of ordinary skill in the art, billing methods are the rules by which a utility generates and presents a bill to the customer. Examples of billing methods are monthly, fixed payment, etc. As also understood to those of ordinary skill in the art, payment methods are the means by which a customer transfers value (money) to the utility. Examples of payment methods are cash, check, pre-authorized direct debit, etc. Prepayment is a billing method and the means through which the customer purchases their prepaid amounts is the payment method. As understood by those of skill in the art, billing and payment methods can be intermingled in a variety of ways. Virtually any billing method can be logically and functionally paired with any payment method.

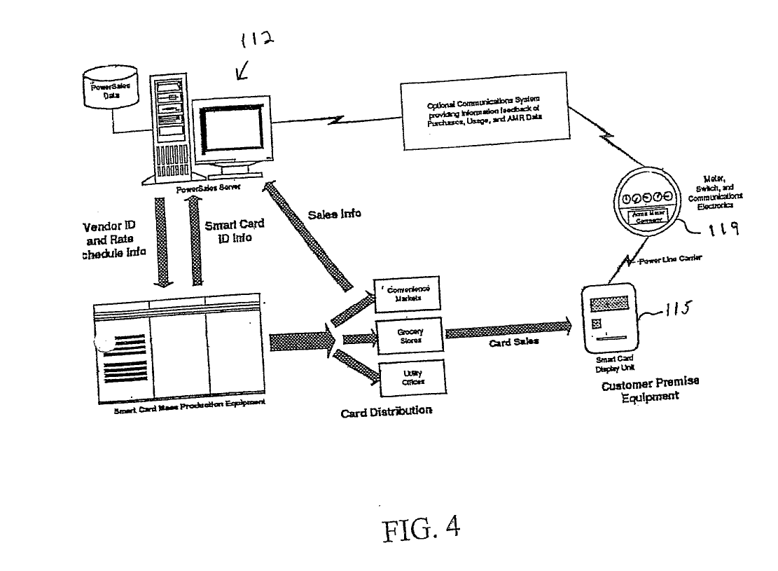

The billing and payment features in accordance with the present invention can be incorporated into an overall system in a number of different ways. For illustration purposes, a few examples of the various embodiments will be described herein. A presently preferred embodiment is illustrated in FIG. 4. As shown, the system comprises one or more user interfaces 115, one or more relays, each preferably comprising a meter 119, such as in the form of either a concentrator meter 14 or a meter 16, with each meter 119 being in communication with each user interface 115, and a control station 112. In this embodiment, the user interface 115 is similar to user interface 15 and is in power line communication with the meter 119, although as noted above, in other embodiments any alternative means for communication between the user interface 115 and meter 119 can also be utilized where desired.

The system of the present invention may support a number of billing methods. These may include postpayment methods in that payment is requested after the usage has occurred, and prepayment, which, as the name implies, requires payment before usage has taken place. The billing method preferably takes into account possible rental charges, credit reviews for late payments, and debt amortization in a predefined manner in a separate document provided by the utility.

The present invention may preferably support an unlimited number of billing schedule dates that coincide with billing cycles of varying length. Each customer account is preferably assigned a particular billing cycle. The billing cycle specifies the individual dates by which meter readings are reported. Because these cycles do not conform to any particular fixed cycle, the host operator of the system is preferably responsible for specifying each billing cycle ending date as they become available and for ensuring that meter reading information is provided by that specific date. Rental charges, credit review of past due amounts, and debt amortization may be taken into account or calculated for each scheduled billing date.

All billing methods may utilize a particular rate schedule. A typical rate schedule for residential usage involves the specification of a number of kWh at a rate, a second amount at a different rate, and so on until all residual usage is charged at what is typically referred to as a base rate.

Time based billing may also be used. Time based billing includes the generation of a bill based on a recurring fixed time interval. The time interval is most commonly a month but may be set based on the billing cycle description above. The FPS system shall be capable to print statements that are associated to postpayment methods.

Fixed payment billing is a variation of time based billing. The fixed payment shall be established by the utility mainframe and downloaded via the host to the field equipment in the manner previously described. Recalculation of this value is preferably done in the following manner: Fixed Payment=Estimated Annual Usage/Number of Billing Periods in Year. The formula to adjust the Fixed Payment after N billing periods may be as follows: IF the Outstanding Balance owed is less than the Fixed Payment THEN No adjustment is made ELSE IF the Outstanding Balance is equal to or greater than the Fixed Payment THEN Outstanding Balance is due immediately and New Fixed Payment=Fixed Payment+(Outstanding Balance/N) ELSE IF the Outstanding Balance overpaid is less than the Fixed Payment THEN No adjustment is made ELSE IF the Outstanding Balance overpaid is greater than the Fixed Payment THEN Outstanding Balance is refunded immediately and New Fixed Payment=Fixed Payment−(Outstanding Balance/N).

The system of the present invention allows for the transfer of funds via an electronic arrangement with a bank designated by the utility. This method is expected to be done in a batch mode. The system also accepts manual payment for those customers not having a suitable credit arrangement or prefer any of the other available payment means.

The billing methods used in the system of the present invention may also incorporate stepped rate schedules. Up to 7 steps plus a base are preferably supported. This also includes the support of any fixed daily charges associated with the maintenance of the account.

The system supports both fixed and future rate schedules. In other words, the system supports the ability to pre-load a rate schedule that will take effect some time into the future. The rate schedule itself is a programmable piece of data that can be specified at the time of installation of the equipment. However, the system also supports the ability to download rate schedules to take effect at a future date. This rate schedule would then be invoked on the specified date.

The present invention also supports multiple tax structures that preferably incorporates up to 3 individual taxes. In addition, the present invention supports compounding of these taxes in the following modes:

### Tax Structure Compounding Options

No compounding

Tax 2 compounds on Tax 1, no Tax 3 compounding

Tax 2 compounds on Tax 1, Tax 3 compounds on Tax 1

Tax 2 compounds on Tax 1, Tax 3 compounds on Tax 1 and Tax 2

Tax 2 does not compound, Tax 3 compounds Tax 2 and Tax 3

Taxes shall be calculated daily and tracked in separate registers.

The present invention also supports the inclusion of extra service equipment. This is equipment with an associated rental charge, which may be included in the billing process. The basis for calculation is preferably daily. The present invention also supports the inclusion of various amounts associated with past due amounts that may originate from: amount past due from past billings, administrative charges associated with past due amounts at a rate of 1.2% calculated every 30 days, transferred amounts from a previous account, other charges such as insufficient funds charges, if applicable.

Prepayment shall allow customers to make advance payments for their electrical usage in amounts conducive to their budgeting practices. Purchases are also capable of being made in various amounts with the limiting factor being any associated credit or bank transaction fees. Payments as per current customer practices are possible if so desired by the customer.

Prepayment mode causes the system to operate in much the same manner as a fuel gauge. A monetary amount may be displayed and will decrease as usage occurs. Upon depletion of the prepaid amount, power will be automatically disconnected as per utility current policies unless the unit is configured with extended service.

Purchases for prepayment and other methods of payment are possible via the display unit through an electronic process utilizing an integrated circuit (IC) or “smart” card in this embodiment, but can be other types of devices as well where desired, such as any magnetic or mag-stripe card, a combination smart card/mag-stripe card or any other suitable type of device, such as a portable floppy disc, CD-ROM, CD-RW and the like. In this embodiment, the smart card is preferably a conventional IC card, for example, including a processor, memory and the capability to upload data from the memory to an external device and the capability to download data from an external device to the memory.

The smart cards can be provided to the customer, such as by mail from the utility or other provider, or obtained directly by the customer/user at a designated location, for example, a distribution center. The distribution center can be provided at the site of the provider or at some other designated location, such as at a convenience store, grocery store, etc. The smart card can be distributed in a number of different ways, such as directly from a clerk or from a distribution terminal or similar device commercially available. The provider can also designate the terms required for the customer/user to obtain the smart cards, for example, purchased or leased for a fee or deposit, for free or based on any other desired terms. Further, where desired, the smart cards can be provided to the customer already having unique customer information preprogrammed into memory, such as a user or site ID and/or a digital signature, such as security codes, as examples.

Alternatively, the smart cards can be provided to the customer without any customer information preprogrammed, and the customer would then have the option to program desired information into memory, such as the user ID and/or security codes. The smart cards can be constructed so that the user can program the information directly into memory, such as by key or touch pad entry, or the programming function can be carried out at the distribution terminal, such as by entering the desired information using the terminal's key or touch pad entry. In the presently preferred embodiment, no unique customer ID, security codes or other information is required to be incorporated into the smart cards.

In addition to prepayment, the present invention may also support any other payment methods allowed by local banking laws and restrictions. The customer will typically pre-arrange for the type of payment method to be used with their account.

Direct debit payment deducts the amount due directly from the customer's specified bank account. In this method, even though the payment source is pre-specified, it is the responsibility of the customer to actually initiate the transaction from the customer display terminal. Payment is not made until this operation takes place. Direct debit may be pre-authorized to allow customers to make payments based on their current utility practices. The present invention preferably handles this in the same manner as a cash payment described below.

There are a number of utility customers who do not have a banking or credit card relationship. Therefore the present invention support cash payments for bills posted. This is preferably accomplished via the normal payment process that the customer would have used prior to implementing the system of the present invention. The utility personnel would then key the payment into the host system or transfer it via a specified format file such that it can be credited during the next update of the field equipment.

The present invention also incorporates a means of paying down outstanding debts of the customer to the utility. This may be accomplished, for example, via a pre-arranged agreement with the utility to make an additional payment toward bad debt each month. This amount is over and above the amount required to pay for current usage. The manner in which this works will differ depending on whether the customer is being billed in prepayment or postpayment mode.

Customers operating in a postpayment mode will establish a prior arrangement with the utility as to how much of their bad debt is paid each month. An “Amount Past Due” display at the user interface shows their total debt. An “Amount to Pay” display may also be provided, which may include the “Amount Due” amount and a fixed amount of their past due debt. Upon payment of this amount, the “Amount Past Due” shall be reduced. It is expected that a customer keeping within the rules of such an agreement shall avoid further past due charges.

An example of this would be a customer who is $500 in debt. The customer's current bill for the billing cycle is $200. However, the customer has made an arrangement with the utility to pay $100 per billing cycle toward the bad debt. In this case the billing display would read:

| | |
|---|---|
| Amount Past Due | $500 |
| Amount Due | $200 |
| Total Owed | $700 |
| Amount to Pay | $300 |

After making a $300 payment, the displays become:

| | |
|---|---|
| Amount Past Due | $400 |
| Amount Due | $0 |
| Total Owed | $400 |
| Amount to Pay | $0 |

In the prepayment mode, the customer has reached an arrangement to credit a portion of each purchase toward the bad debt. This may be, for example, on a percentage of a fixed amount. As an example, assume a customer with a $500 debt. He has reached an agreement with the utility that 10% of all purchases shall be credited to bad debt. If the customer makes a $20 purchase, the prepayment amount added to the system shall be $18 with $2 credited against the bad debt. By selecting various percentages or fixed amounts the utility can determine the pace by which bad debts are paid.

In operation, the smart cards of the payment system are preferably credited with a designated amount of prepaid or other payment service. Any desired increments for the prepaid service can be used, for example, in one embodiment, choices of 5, 10 or 20 dollars can be provided, although as should be understood, any other increment can be selected where desired.

In the preferred embodiment, there are a number of different ways that the service can be credited on the smart cards. Preferably, the designated amount of service is purchased or arranged by the customer at the distribution center, such as directly from the distribution terminal or with the designated information programmed earlier by the provider and already on the smart card when obtained by the customer.

In embodiments where the payment service is obtained from the distribution terminal, the user preferably places the smart card into a designated area and then selects the service using the terminal display, similar to transactions using a conventional money access center (MAC) machine. As indicated above, the system can be configured so that a personal identification number (PIN) is required for access of the distribution terminal. The system can also be constructed so that the distribution terminal is a stand alone device or linked with other devices as well, such as with the control station 112 and/or with the same or similar network to which MAC machines are tied into.

The system can be configured so that the user has one or a variety of options for handling payments, such as any of the following. For instance, the customer can be required to insert money into the terminal and that designated amount is then encoded onto the smart card. Alternatively, the customer can designate that a desired amount of money be withdrawn from a linked bank account or the provider can maintain an escrow account, such as tied into the control station 112, and then that desired amount is encoded onto the smart card. Further, rather than tied into a money account, such as tied into a prepaid debit account, a customer account such as a credit account can be maintained by the provider, such as at the control station 112, and a bill can be generated by the provider and sent to the user at specified intervals, based on the amount of prepaid service selected by the customer and encoded on the smart card during that time period.

In addition, in this embodiment, the system can also be configured so that one or more specific rate schedules are encoded onto the smart card at the same time the prepaid service is downloaded on the smart card. The system can further include an effective date associated with the specific rate schedule to allow future rate deployment.

The payment service stored on the smart card is then preferably input into the system via the user interface 115. For this purpose, the user interface 115 preferably includes a smart card reader, such as any suitable commercially available type, and a processor for system control. The user interface 115 in this embodiment further preferably includes a display, which can be any desired conventional type, such as an LCD or alphanumeric display. The user interface 115 can be configured so that user information is provided to the customer via the display, such as account status as to balance, service used on an hourly, daily and monthly basis, amount of last purchase and/or current rate being charged (i.e., per kilowatt hour), as examples.

As indicated above, the user interface 115 in this embodiment is in PLC communication with the meter, and for this purpose, user interface 115 includes a conventional plug, which is then inserted into a power outlet. Further, in the present embodiment, the user interface 115 can also include a battery for back-up power in case of power outages, such as to protect against loss of data. Also, the user interface 115 can be programmed with ID and/or security codes where desired. In operation, the prepaid service input into the system via the smart card reader is preferably stored in memory within the user interface 115, or alternatively it can be stored within memory in another device, such as the meter 119.

The meter 119 in this embodiment preferably includes a connect/disconnect mechanism, such as a switch or other type of device, to regulate the dispensing of utility service. In other embodiments, where metering is not provided, the connect/disconnect mechanism would similarly regulate system operation. In operation, the connect/disconnect mechanism is preferably responsive to the amount of payment service input in the system. For example, in this embodiment, the connect/disconnect mechanism is preferably in the connect mode when there is any amount of the prepaid service remaining in the system and is in the disconnect mode when the amount of prepaid service has been exhausted. The control of the connect/disconnect mechanism can be regulated from any part of the system, such as by the control 112, the user interface 115 or the meter 119 in this embodiment. Preferably, in this embodiment the processor of the user interface 115 monitors the amount of prepaid service stored in memory and is in communication with the connect/disconnect mechanism directly or through a processor within the meter 119 to control operation of the connect/disconnect mechanism.

Power interruption may occur only if a disconnect command is downloaded from the host to the field equipment. This command can be downloaded well in advance of the target disconnect date or on the day of the disconnect. If for any reason the system is powered down on the specific date of the disconnect, the disconnect command may be implemented following power restoration.

In any case, power will preferably never be disconnected without first contacting the host on the day of the disconnection to make sure the disconnect command has not been aborted. The system can be programmed to not disconnect the power during the night but at a time to be specified during the daylight hours. This time shall be also part of the disconnect command. Should the field equipment be unable to contact the host on the day of the disconnect command, the disconnect would preferably be implemented.

The system can also be programmed to not restore service without making sure that someone is on the premises. This may be done by requiring the customer to perform a manual update to the system through the display unit or actually making a payment in a satisfactory amount through the display unit.

During the disconnect time, the field equipment may periodically attempt to contact the host to receive any further commands. Should a reconnect command be issued during any of those communications sessions, the power will preferably not be reconnected until someone successfully enters a correct PIN code in the display terminal if the system is programmed to make sure someone is home first.

In addition, in this embodiment, another feature is that data corresponding to the reading of the meter can be uploaded and stored onto the smart card at substantially the same time, and preferably at the same time, as the prepaid service is downloaded from the smart card into the user interface 115. For this purpose, the user interface 115 can be configured to also include a smart card writer or a combination smart card reader/writer, which can be any commercially available type. The data corresponding to the meter read can be transmitted from the processor in meter 119 directly to the smart card, transmitted to the memory on the user interface 115, which is in turn uploaded onto the smart card, or alternatively other schemes can be used for this same purpose.

Further, the data corresponding to the meter read stored in memory on the smart card can be downloaded at some other desired time and/or location in the system to monitor the meter read data. For example, the system can be configured so that the stored meter read data is uploaded into the system the next time the customer purchases additional prepaid service from the distribution terminal. The meter read data then can be communicated from the distribution terminal to some other location, such as to the control station 112 for additional processing when desired, such as for verification purposes. For example, the control station 112 can compare the meter read data against either actual read data taken at the meter or a calculated estimate based on the amount of prepaid service purchased by the customer the previous time and the corresponding rate.

Further, the meter 119 in this embodiment is preferably in communication with the control station 112 either directly or through one or more intervening elements, similar to the meter 16/concentrator meter 14 with the control 12. In this embodiment, there preferably is two-way communication between the meter 119 and control station 112, such as for the various reasons discussed above, e.g., anything associated with meter reading or more general communication as examples. In other embodiments, the system can be configured to accommodate only one way communication between the meter 119 and control station 112 in either direction where desired. In still other embodiments, the system can be configured so that there is no communication transmitted directly or indirectly between the meter 119 and control station 112. In these embodiments, the only manner that data can be passed between the meter 119 and control station 112 is through the smart card, in particular, where the smart card both carries prepaid money information as well as meter read data.

In another exemplary embodiment, the smart cards are preferably of a type capable of being mass produced in fixed amount values and distributed to various points of sale with no supporting computer infrastructure. The smart cards in this embodiment are non-site specific and that any card is capable of being accepted by any user interface. Each card also preferably has a unique ID that can ultimately be used to determine fraud. Other security measures from the card can be used where desired. In addition to the value information, the card contains at least one and preferably up to 5 rate schedules. The field hardware selects the appropriate rate schedule from the 5 and use is based on its configuration ID. The user interface in this embodiment preferably includes a display of the LCD type with 1 to 3 pushbuttons and a 1 line by 16 line character LCD display. The user interface accepts non-site specific smart cards. The display preferably saves the card ID numbers of a defined number of cards of the last smart cards accepted, such as the last 24 cards, in the event that an audit is performed on the system. The user interface preferably communicates with the external meter via power line carrier, with no additional wiring needed for communication. In order to support power line communication when power is off, the user interface preferably includes a consumer replaceable battery, which energizes the user interface when power is off and a card is inserted into the card reader.

The meter in this embodiment preferably contains a disconnect switch and control electronics, and communicates with the display via power line carrier. The present invention is also capable of printing the usage and purchase history. For example, the system may provide a purchase/payment history consisting of the last 10 purchases or payment made.

The control station or host computer is preferably a single PC running a Microsoft Windows based program. Preferably, the computer/software is not responsible for vending cards but to simply manage customer installations, track card production, and organize necessary information for card production, such as rate schedules, taxes, etc.

An advantage of the system of the present embodiment is that minimal installation is required since there is no wiring between the meter and user interface/display. The smart cards are preferably deployed such as they are readily available on a 24 hour basis. Customers preferably purchase the cards in fixed increments from the various points of distribution, such as $5, $10, and $20.

In one modification of the system in the present embodiment, a cluster communications controller can be added, preferably sitting on the secondary side of the power transformer where the systems are preferably installed and communicate with them via power line carrier. The unit would in turn preferably communicate with a host computer via some other type of communications method, such as telephone, cellular, radio, etc. Advantages of this aspect of the present embodiment is that it creates a great deal of flexibility, including, card usage reporting to further enhance fraud or tampering, AMR reporting capability, cardless value transactions via electronic funds transfer and greater variety of rate schedule and configuration capabilities.

Tying the billing and payment methods together are the payment cycles. These cycles include the time period from when the bill is posted until payment has been made and verified. The payment cycle preferably supports a variety of options based on the configuration parameters. Specific parameters may include the billing date, the payment period, the past due period, and the auto-disconnect point.

The billing date is the date on which the amount used is due to be paid. It is preferred that this amount will be frozen and subsequent usage will begin to accumulate separately. This billing date can be set to traditional monthly periods or to other time periods, which may be more suitable for the customer's billing situation. The payment period is the time period following the billing date within which the customer can pay their bill without administrative and interest charges. This payment period may be configured based on utility current practices. The past due period is the time period following the payment period during which the customer incurs an administration charge for nonpayment of the bill. This administration charge is preferably be calculated in accordance with utility current practices. The auto-disconnect point is the point at which all prior payment periods have expired. At that time, with additional consideration given for nighttime and winter, the service may be disconnected. The utility policies and modalities will typically serve as the guiding considerations.

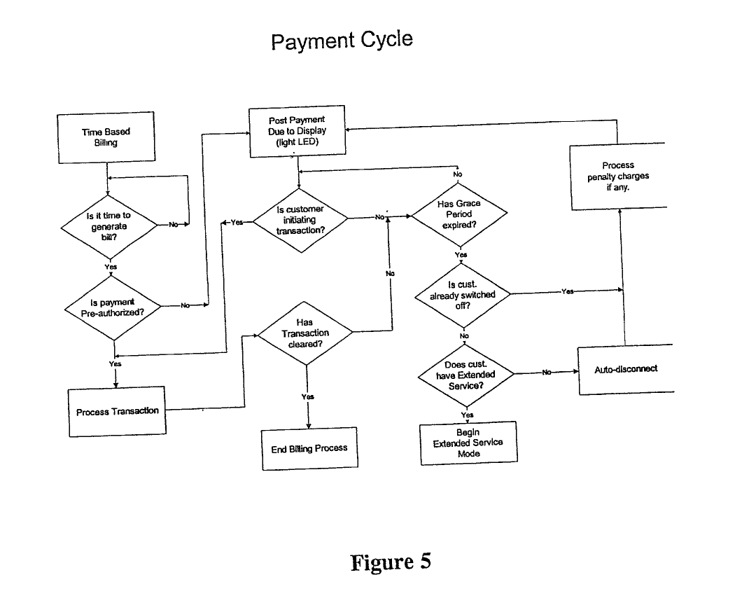

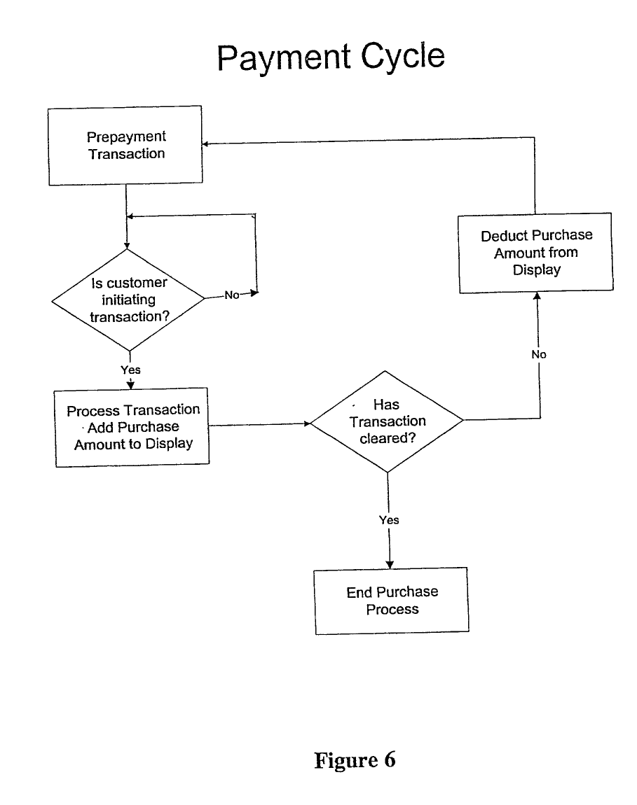

A flow chart of the typical payment cycle is shown in FIG. 5. This cycle is suitable for all forms of billing methods except prepayment. FIG. 5 does not include past due amount considerations. The prepayment payment cycle is somewhat different. This is mainly due to the fact that this cycle does not need to take any punitive action for a payment not being made. That process will occur naturally as the customer's prepaid value goes to zero and is shown in FIG. 6.

It will be recognized by those skilled in the art that changes may be made by the above-described embodiments of the invention without departing from the broad inventive concepts thereof. It is understood, therefore, that this invention is not limited to the particular embodiments disclosed, but it is intended to cover all modifications, which are within the scope and spirit of the invention as defined by the appended claims.

We claim:

1. A method for customers to communicate with and pay a utility for at least one utility service, said method comprising the steps of:
establishing a customer account with said customer, said customer account including a billing method and a payment method;
providing a communication system comprising a utility host, a customer interface, and a control assembly programmed to control said utility service and communication between said utility host and said customer interface;
communicating payment information to and from said customer using said communication system to complete payment of at least a portion of a customer balance on said customer account in accordance with said billing method and said payment method.

2. The method of claim 1, further comprising the step of communicating customer account and utility service information to and from said customer using said communication system.

3. The method of claim 2, wherein said customer account and utility service information comprises one or more selected from the group consisting of automatic meter reads, outage/restoral monitoring, customer consumption readings, Time-Of-Use (TOU) reporting, billing capability, tamper detections/deterrence, deferment of peak use through TOU rate information, Real Time Pricing (RTP), headline/local news, financial quotes, energy information, home monitoring and appliance control.

4. The method of claim 3, wherein said customer account and utility service information is provided as customized or pre-defined messages to particular customer accounts.

5. The method of claim 1, further comprising the step disconnecting and/or reconnecting said utility service using said communication system based upon a comparison of said customer account with said payment information.

6. The method of claim 1, further comprising the step of managing the transfer of said utility service to a new customer or between customers using said communication system.

7. The method of claim 1, further comprising the step of providing customer account usage information for said utility service using said communication system

8. The method of claim 7, wherein said customer account usage information comprises one or more selected from the group consisting of amount used, amount remaining, rate of utility service usage, rate of charge, money used today, money used yesterday, money used this month, and utility service usage over the past twelve months.

9. The method of claim 1, wherein said billing method comprises one or more selected from the group consisting of time based billing, fixed payment based pilling, or prepayment billing.

10. The method of claim 1, wherein said payment method comprises one or more selected from the group consisting of direct debit, pre-authorized direct debit, credit card charging, cash payment, check payment, and debt management.

11. The method of claim 10, wherein said debt management includes a postpayment mode and a prepayment mode.

12. The method of claim 1, further comprising the step of using a smart card to store said payment information.

13. The method of claim 1, wherein said billing method include at least one rate schedule.

14. The method of claim 1, wherein said payment information is communicated in accordance with a payment cycle.

15. The method of claim 1, wherein said payment cycle supports one or more parameters selected from the group consisting of a billing date, a payment period, a past due period, and a disconnect point.

16. A communication system for customers to communicate with and pay a utility for at least one utility service comprising:
a utility host programmed to store a customer account for said customer, said customer account including a billing method and a payment method;
a customer interface to communicate payment information to and from said customer to complete payment of at least a portion of a customer balance on said customer account in accordance with said billing method and said payment method; and
a control assembly in communication with said utility host and said customer interface, said control assembly being programmed to control said utility service.

17. The system of claim 16, wherein said communication system is programmed to communicate customer account and utility service information to and from said customer.

18. The system of claim 17, wherein said customer account and utility service information comprises one or more selected from the group consisting of automatic meter reads, outage/restoral monitoring, customer consumption readings, Time-Of-Use (TOU) reporting, billing capability, tamper detections/deterrence, deferment of peak use through TOU rate information, Real Time Pricing (RTP), headline/local news, financial quotes, energy information, home monitoring and appliance control.

19. The system of claim 18, wherein said customer account and utility service information is provided as customized or pre-defined messages to particular customer accounts.

20. The system of claim 16, wherein said control assembly is programmed to disconnect and/or reconnect said utility service based upon a comparison of said customer account with said payment information.

21. The system of claim 16, wherein said communication system is programmed to manage the transfer of said utility service to a new customer or between customers.

22. The system of claim 16, wherein said communication system is programmed to provide customer account usage information for said utility service using said communication system

23. The system of claim 22, wherein said customer account usage information comprises one or more selected from the group consisting of amount used, amount remaining, rate of utility service usage, rate of charge, money used today, money used yesterday, money used this month, and utility service usage over the past twelve months.

24. The system of claim 16, wherein said billing method comprises one or more selected from the group consisting of time based billing, fixed payment based pilling, or prepayment billing.

25. The system of claim 16, wherein said payment method comprises one or more selected from the group consisting of direct debit, pre-authorized direct debit, credit card charging, cash payment, check payment, and debt management.

26. The system of claim 25, wherein said debt management includes a postpayment mode and a prepayment mode.

27. The system of claim 16, further comprising a smart card reader for reading a smart card storing said payment information.

28. The system of claim 16, wherein said billing method include a rate schedule.

29. The system of claim 16, wherein said payment information is communicated in accordance with a payment cycle.

30. The system of claim 16, wherein said payment cycle supports one or more parameters selected from the group consisting of a billing date, a payment period, a past due period, and a disconnect point.

31. The system of claim 16, wherein said utility host comprises a computer running application software.

32. The system of claim 16, wherein said customer interface comprises an LCD display, navigation push-buttons, a numeric keypad, and multi-colored LED's.

33. The system of claim 16, wherein said control assembly comprises a power switch, control electronics programmed to complete usage calculations and external communications, and a transceiver for communicating with said utility host.

34. A communication system for customers to remotely communicate with and pay a utility for at least one utility service comprising a customer control system at a location remote from said utility, said customer interface being programmed to communicate payment information to and from said customer to complete payment of at least a portion of a customer balance on a customer account in accordance with a billing method and a payment method stored at said utility; and to control said utility service to said customer.
